(19) United States
(12) Patent Application Publication
(10) Pub. No.: US 2006/0091642 A1
(43) Pub. Date: May 4, 2006

(54) Adjustable height, protective folding step for vehicles

(76) Inventor: Guy Robert Goldstein, Norco, CA (US)

Correspondence Address: Curt Harrington, Suite 250, 6300 State University Drive, Long Beach, CA, 90815, US

(21) Appl. No.: 10/978,130

(22) Filed: Oct. 29, 2004

(51) Int. Cl. B60D 1/00

(52) U.S. Cl. 280/504

(57) ABSTRACT

An adjustable height, protective folding step is mounted into an existing receiver hitch of a vehicle, preferably a truck or sport utility vehicle. In the up position, the protective folding step is angled and preferably extends or appears to extend partially underneath the rear of the vehicle to create an integrated appearance. The mounting distance and support stability of the folding step enables it to provide significant protection to the vehicle bumper, both by being spaced away from the bumper and by having a top horizontal tubular extent that follows the bumper width and thus helps spread impact. Added advantage of adjustable vertical placement is had by providing a multiplicity of pivot apertures in a pivot locking plate so that users can adjustably install the protective folding step at the proper height with respect to a vehicle bumper, and in particular in a position which will avoid obscuring the vehicle's license plate. The protective folding step is used by simply releasing the vertical holding mechanism, typically a latch and pin, and allowing the step, including the tubular portion supported by a structural support plate, to pivot to a generally horizontal position. A finished plate which may be tack welded or replaceably bolted to lugs supported by the tubular portion of the protective folding step.

### FIELD OF THE INVENTION

The present invention relates to improvements in the technology relating to vehicle safety and preservation, and more particularly to a trailer hitch mounted rear folding step which is useful for vehicle access, vehicle bumper protection and aesthetic enhancement.

### BACKGROUND OF THE INVENTION

Several structures are known to be used in conjunction with trailer hitch receivers which are conventionally available on contemporary vehicles, and many more than simple trailer hitch inserts. Manufacturers have designed recreational equipment, bicycle carriers and more. One class of receiver hitch relates to the provision of a step-up, especially for trucks, in which a user is provided a step to position themselves to either enter the back bed of a truck or to look inside the truck bed.

Conventional trucks, especially pickups, are built bigger and higher than in the past. Unlike pickup trucks in the 60's and 70's, modern pickups are manufactured for style as well as utility, with the extended step up bumpers being replaced by integral bumpers. The height of the bed and the lack of a step bumper has created a need to enable users to more safely climb onto the back of their vehicles. In some cases, structure is provided which either cannot be left in place during operation of the vehicle or which have to have special mechanisms to enable them to be effectively stored under the vehicle.

Further, the move toward a more “automobile-like” appearance has caused bumper-body integration in a move which has sacrificed utility for style. With the integration of bumpers into the body contour has come the high cost of repair for small hits of the bumper. Conventional truck bumpers are now as delicate and subject to damage as their passenger automobile counterparts. None of the step structures which are currently supplied with regard to receiver hitch structures are built to protect conventional bumpers, most are too low or act as a replacement bumper on a vehicle.

Further, the ability to effectively protect conventional bumpers requires several characteristics. First, any structure which provides bumper protection must also not obstruct the license plate area. The license plate should be viewable from a wide angle and must be viewable from a following vehicle driver. Secondly, protection is not effective if the structure provided is so close to the bumper that it can be driven into the bumper at low impact. Third, if an impact occurs in which the bumper protector resistance is overcome and some contact with the bumper is made, it should be a contact distributed as evenly over the surface of the bumper as possible, to minimize any deformation of the bumper.

Lastly, any structures which are utilized with modern, stylish trucks must fit the level of stylishness associated with the overall design of the vehicle. All of the known rear steps have an odd appearance and clash with the style with modern trucks. All vehicle accessories should have maximum aesthetic integration with the vehicles on which they are placed regardless of the widely differing types and styles of vehicles on which they are placed. The highest value to the consumer occurs when utilitarian structures are stylishly integrated into the vehicles whose capabilities are enhanced.

### SUMMARY OF THE INVENTION

An adjustable height, protective folding step is mounted into an existing receiver hitch of a vehicle, preferably a truck or sport utility vehicle. In the up position, the protective folding step is angled and preferably extends or appears to extend partially underneath the rear of the vehicle to create an integrated appearance. The mounting distance and support stability of the folding step enables it to provide significant protection to the vehicle bumper, both by being spaced away from the bumper, by having a top horizontal tubular extent that follows the bumper width and thus helps spread any impact large enough to deform the step, into an even application of force across the middle width of the bumper, to thus provide increased impact resistance along with mitigation of damage to the bumper on impact. In an impact larger enough to damage the step by deformation, but not damaging to the bumper, the protective folding step can simply be removed and repaired or replaced at a fraction of the cost of bumper repair.

The protective folding step has the added advantage of adjustable vertical placement by providing a multiplicity of pivot apertures in a pivot locking plate so that users can adjustably install the protective folding step at the proper height with respect to a vehicle bumper, and in particular in a position which will avoid obscuring the vehicle's license plate.

The protective folding step is used by simply releasing the vertical holding mechanism, typically a latch and pin, and allowing the step, including the tubular portion supported by a structural support plate, to pivot to a generally horizontal position. The user can then step up on the protective folding step to enable, for example, entry into the bed of a truck on which the protective folding step is attached, or to get better access to the roof of a sport utility vehicle. Once the user is finished, the protective folding step is simply lifted up, similar to lifting a tailgate, and the protective folding step is locked into an almost vertical position, in a spaced apart relationship to the vehicle's bumper.

The protective folding step has structure for supporting a finished plate which may be tack welded or bolted to lugs supported by the tubular portion of the protective folding step. Where the finished plate is bolted, change out of the finished plate may be facilitated. Users may keep a number of plates for interchange and for style, color coordination, or message placement. Further, if the finish plate is ever damaged due to vandalism or accident, it may also be similarly replaced.

### BRIEF DESCRIPTION OF THE DRAWINGS

The invention, its configuration, construction, and operation will be best further described in the following detailed description, taken in conjunction with the accompanying drawings in which:

FIG. 1 is a rear view of an automotive truck fitted with the inventive folding step shown in the up position;

FIG. 2 is a right rear view of the vehicle in FIG. 1 and illustrating the side profile of the folding step;

FIG. 3 is a view shown as in FIG. 2, but with the folding step shown in a down position;

FIG. 4 is a top view of the folding step in accord with the position of FIG. 3 and;

FIG. 5 is a side view illustrating one possible latching arrangement, as well as the multiple pivot apertures for vertical adjustability.

### DETAILED DESCRIPTION OF THE PREFERRED EMBODIMENT

The description and operation of the invention will be best initiated with reference to FIG. 1 which illustrates a rear plan view of a truck 11. For further reference, the truck 11 will likely have a tailgate 13, tail lights 15, and an integrated wrap around bumper 17. More modern trucks have bumpers which are integrated into the body style, as opposed to earlier vehicles having bumpers which are more separated from the body style. Bumper 17 may preferably have a designated area, such as a depression 19 for mounting of a license plate 21.

Below the bumper 17, the adjustable height, protective folding step 31 is seen. Protective folding step 31 has a structural tubular portion 33 and a finished plate 35 supported adjacent the structural tubular portion 33. The finished plate 35 is supported by support lugs (to be shown later) which are attached to the structural tubular portion 33. The structural tubular portion 33 is supported by a structural support plate 37 which is indicated in dashed line format.

The plan view of FIG. 1 illustrates the rear view of the truck 11 as it would be seen from a following vehicle. Note that the adjustable height, protective folding step 31 is located such that license plate 21 is visible. The upper extent of protective folding step 31 which is seen in FIG. 1 is inclined rearwardly. The uppermost portion of adjustable height, protective folding step 31 is most rearward, with the lowermost portion possibly extending partially underneath the bumper 11. The two ends of the tubular portion are curved toward the front of the truck 11 and abruptly after a short curved portion. This gives a visual impression that the structural tubular portion 33 is part of other structural support extending from underneath the truck 11. This visual impression is derived for any view of the rear of the truck which is not from a perspective directly lateral and below the truck 11. As such, it contributes to the aesthetic of the truck 11 and further disguises and covers a trailer hitch bracket (to be shown).

Finished plate 35 can preferably mirrored finish metal, or in the alternative, a customized plate 35 with graphics colors, and the like can be employed. Typically there is gap between the plate 35 and the structural tubular portion 33 where the overall plate area is to be a highly decorative and possibly interchangeable. In this configuration, the structural support plate 37 supports the structural tubular portion 33, and the structural tubular portion 33 supports the decorative plate 35 with lugs or other supports. This facilitates the use of material for decorative plate 35 which is inconsistent with welding to the structural tubular portion 33.

In the alternative, the decorative plate 35 could be provided as a thicker, welded plate, especially welded to the structural tubular portion 33 about its periphery. Further finishing of a fully welded plate 35 would be more difficult as access would have to be had to the plate's surface about a tubular member 33 curved to a three dimensional extent.

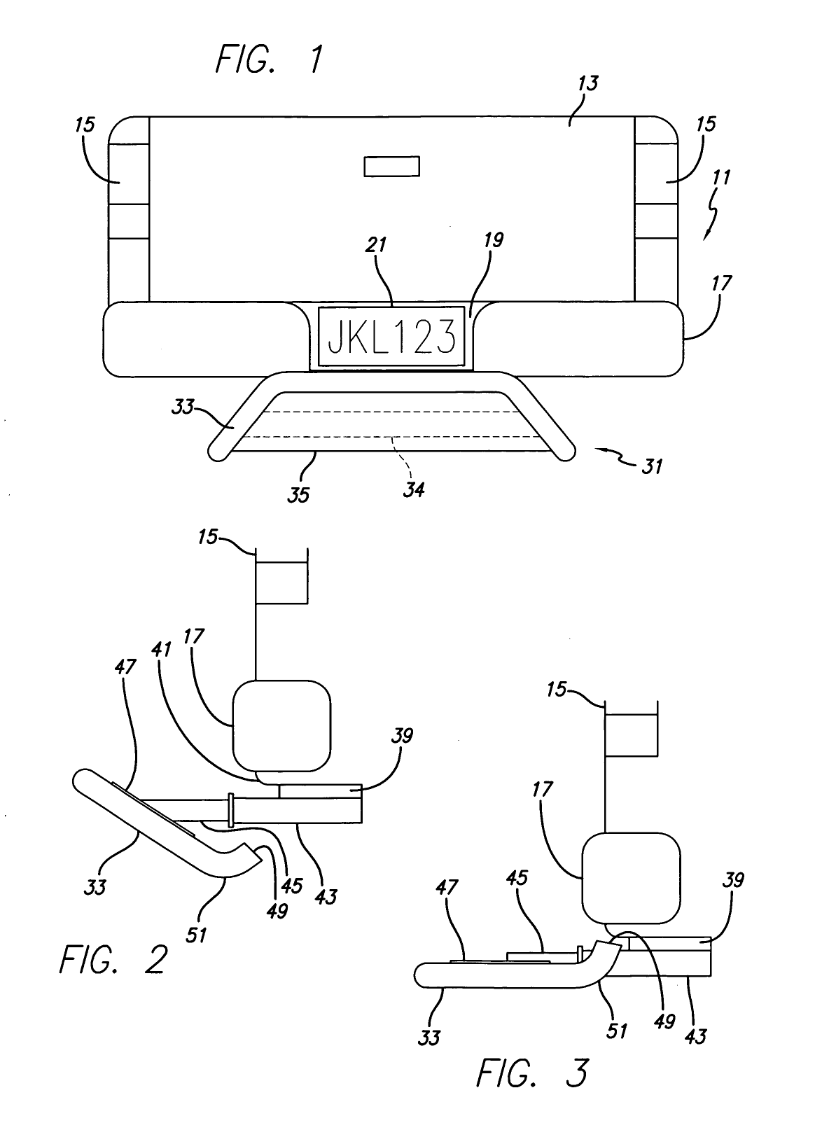

Referring to FIG. 2, a side view of the rear of the truck 11 is shown. Underneath the bumper 17 and to a structural chassis member 39 underneath body material 41 is a receiver hitch 43 which is conventional, commercially available, and which is a utility structure used to accommodate inserts for various trailer hitch structures and auxiliary structures. The inclusion of receiver hitch 43 structures have enabled user selectable structural attachment to a vehicle without the necessity for extraneous attachment of other structures to the vehicle chassis.

Receiver hitch 43 is shown as receiving an insert support 45 in a conventional manner. The rearwardly extending end of insert support 45 is partially obscured by the structural tubular portion 33, however a portion of a pivot locking plate 47 is seen. Pivot locking plate 47 has an extent which is seen as extending both above and below the insert support 45. As will be seen, pivot locking plate 47 can be adjustably engaged at different heights to raise and lower the structural tubular portion 33 and structural support plate 37 with respect to the insert support 45. This will enable owners trucks with license plates 21 which are mounted at a lower level to adjust the adjustable height, protective folding step 31 to a lower height to keep the license plate 21 visible.

Also seen in FIG. 2 is the lower end 49 of the structural tubular portion 33 which is shown as ending just after a curve or bend 51 in the structural tubular portion 33. This bend 51 has the dual purpose of providing an aesthetic of underneath support from the truck 11, while not providing any interference with the body material 49 or bumper 17 during the pivoting folding of the structural tubular portion 33 with respect to the insert support 45.

Referring to FIG. 3, a view of the adjustable height, protective folding step 31 pivotally moved to its generally horizontal position, is shown. In this position, the structural support plate 47 forms the main surface upon which a user may step-up to gain a more stable access to the rear bed of the truck 11. The structural support plate 37 and the structural tubular portion 33 provide the bulk of the area onto which the user may step. The areas to either side of the pivot locking plate 47 may be optionally covered with a diamond non-skid plate or other flat plate where it is desired to provide a more flattened surface. In the alternative, the structural support plate 37 may be welded to the structural tubular portion 33 in a position almost covering the structural tubular portion 33 rear side. However, some depth of mounting of the adjustable height, protective folding step 31 will be sacrificed, with some erosion of aesthetics.

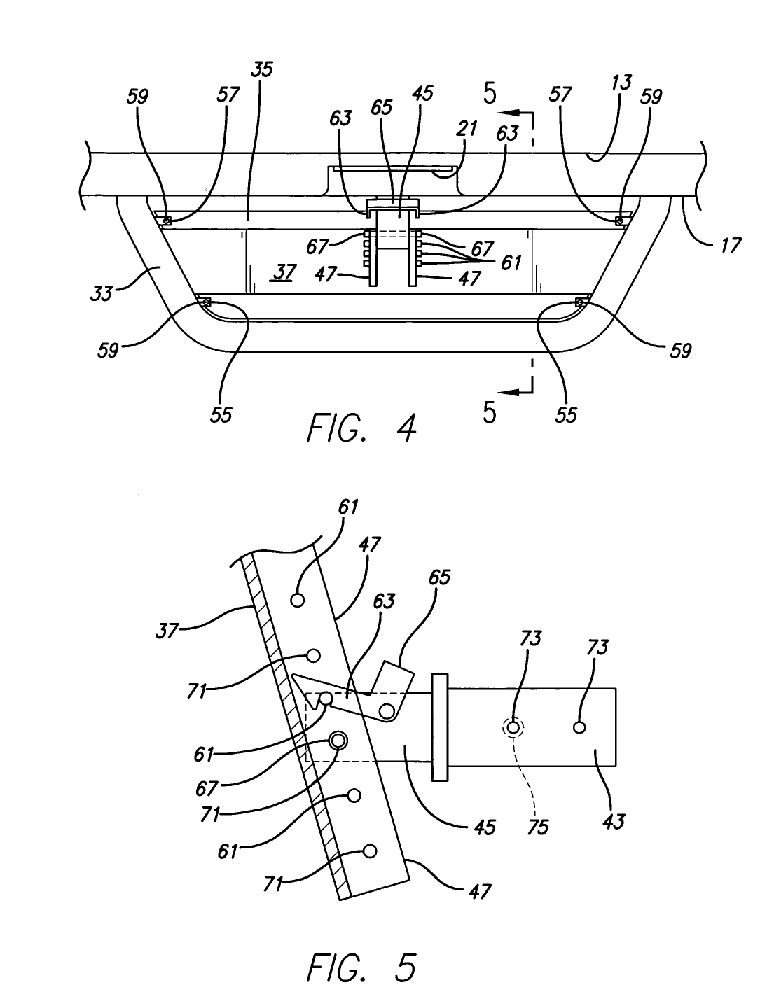

Referring to FIG. 4, a top view looking down upon the rear of the truck bumper 17 and tailgate 13 is shown. In the configuration of FIG. 1, where the finished plate 35 is used, it can now be seen with respect to the structural support plate 37. The structural support plate 37 is seen welded to the structural tubular support 33 at the opposite angled ends of the structural support plate 37 which is the manner in which the structural tubular support 33 derives its structural support. This manner of attachment creates a gap between structural support plate 37 and the upper extent of structural tubular portion 33 parallel to the structural support plate 37. Within this gap a pair of oppositely placed upper lugs 55 engage the upper end of the finished plate 35. A pair of lower lugs 57 engage the finished plate 35 at its lower end. The attachment to the lugs 55 and 57 can be by tack welding, or by threaded members 59, both, or other means of secure attachment. Where threaded members 59 are used, the finished plate 35 can be made to be interchangeable.

Not in FIG. 4 that the adjustable height, protective folding step 31 is seen in a horizontal position with respect to the ground and generally perpendicular to the tail gate 13. This is the view of the user looking down at the step 31 as it is being used as a step. Where the structural support plate 37 is welded down into the midpoint of structural tubular support 33, it would be difficult for a user's shoe to come off of the structural support plate 37 and disturb the finished plate 37. The aforementioned diamond or skid plate can be added to fill in most of the area seen in FIG. 4 surrounding a pair of spaced apart pivot locking plates 47, so called because they enables the adjustable height, protective folding step 31 to both pivot and lock with respect to insert support 35.

At the center of the structural support plate 37, the pivot locking plates 47 are shown as having a series of oppositely disposed pins 61 which are positioned to engage a pair of latches 63 which may be joined by a connector bar 65 to optionally, but preferably enable simultaneous operation. Where provided with enhanced structural integrity, it is possible that only one of the latches 63 may be needed. Appropriate spacers may be used to enable the latches 63 to have good pivoting support while gapped away from insert support 45 sufficient to accommodate and enable the latches 63 to reach the outside of the pivot locking plates 47.

Also seen in dashed line format is a pivot bolt 67 which extends through the pivot locking plates 47 and through the insert support 45. Pivot bolt 67 may be removed by the user and re-inserted through different apertures in the pivot locking plates 47 to allow adjustment of the protective folding step 31, which becomes an adjustable height when folding step 31 is in the position seen in FIGS. 1 and 2 and which becomes an adjustable forward and rearward position when seen in FIGS. 3 and 4.

Referring to FIG. 5, a side partial sectional view taken along line 5-5 of FIG. 4 illustrates the manner of latching for the adjustable height, protective folding step 31. The structural support plate 37 is shown in sectional view as weldably attached to one of the pivot locking plates 47 seen from the viewpoint of FIG. 5, the other pivot locking plate 47 being a mirror image of the view in FIG. 5, and located behind the one seen in FIG. 5. A series of structures seen as generally linear, but which could be staggered include the pins 61 taken with respect to a series of pivot apertures 71, one of which is engaged by pivot bolt 67. The angle of the structural support plate 37 and the pivot locking plate 47 may correspond to a vertical alignment between the pins 61 and the pivot apertures 71, but this need not be the case. Any suitable orientation which enables a pin 61 to be engaged by the latch 63 when the appropriate corresponding pivot aperture 71 is engaged by the pivot bolt 67 is preferable.

To change the height of the adjustable height, protective folding step 31, all the user need do is to unlatch the pivot pin 61 and remove the pivot bolt 67 to disengage the pivot locking plates 47 from pivoting engagement with the insert support 45. The desired pivot aperture 71 is then aligned with the bore (not separately shown) extending through insert support 45, and the pivot bolt 67 is then re-inserted through the pivot locking plates 47 and insert support 45 and re-secured. The adjustable height, protective folding step 31 is then secured back into locked position.

As can also be seen from FIG. 5, the latch 63 is preferably shaped as a cam guide to facilitate movement of the latch 63 aside when the pivot locking plate 47 pivots up when the adjustable height, protective folding step 31 is brought to an upright position. Similarly unlocking may preferably entail some upward pressure on the adjustable height, protective folding step 31 to overcome any resistance to the disengagement of the latch 63 in addition to any spring action which may be used in the latch 63.

Further, conventional attachment methods between the insert support 45 and the receiver hitch 43 will preferably enable the adjustable height, protective folding step 31 to be mounted at different distances from the rear of the truck 11. One structure which would enable such variance are lateral bolt apertures 73 seen in FIG. 5 which may be engaged by locking bolts 75.

While the present invention has been described in terms of a adjustable height, protective folding step, & more particularly to a structure which provides some utility for the user and some protection for the vehicle, the mechanisms and support techniques disclosed can be applied to other devices.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A folding step comprising:
an insert support for being received in a vehicle receiver hitch;
a protective folding step structure pivotally mounted with respect to said insert support for pivoting movement between a substantially horizontal down position for use as a step, and an up position ranging from a substantially vertical position to a position rearwardly inclined from a vertical position; and
a latch mechanism operable between said insert support and said protective folding step to enable said protective folding step to be locked in the up position.

2. The folding step as recited in claim 1, wherein said protective folding step structure further comprises:
a structural support plate pivotally mounted with respect to said insert support; and
a structural tubular portion attached to said structural support plate.

3. The folding step as recited in claim 2, wherein said protective folding step structure further comprises at least one support lug, supported by said structural tubular portion; and a finished plate attached to said at least one support lug.

4. The folding step as recited in claim 2, wherein said protective folding step structure further comprises:
at least one pivot locking plate attached to said structural support plate for pivotally connecting said folding step structure to said insert support; and
wherein said latch mechanism includes at least one latch hook pivotable with respect to one of said insert support and said pivot locking plate, and engageable with a complementary latch engageable structure on the other of said insert support and said pivot locking plate to lock said folding step in said up position.

5. The folding step as recited in claim 4, wherein said complementary latch engageable structure is a protruding pin.

6. The folding step as recited in claim 4, wherein said latch mechanism includes at least a pair of latch hooks each engageable with its own associated a protruding pin.

7. The folding step as recited in claim 6, wherein said pair of latch hooks are linked to operate together.
